(19) United States
(12) Patent Application Publication
(10) Pub. No.: US 2006/0015922 A1
(43) Pub. Date: Jan. 19, 2006

(54) Method of processing files for data broadcasting

(75) Inventors: Chang Sup Lee, Seoul (KR); Suk Won Park, Seoul (KR)

Correspondence Address: JONATHAN Y. KANG, ESQ.;LEE, HONG, DEGERMAN, KANG & SCHMADEKA, 14th Floor, 801 S. Figueroa Street, Los Angeles, CA, 90017, US

(73) Assignee: LG Electronics Inc.

(21) Appl. No.: 11/184,298

(22) Filed: Jul. 18, 2005

(30) Foreign Application Priority Data
Jul. 19, 2004 (KR) 2004-0055878

(51) Int. Cl. H04N 7/173; H04N 7/16

(52) U.S. Cl. 725/134; 725/142; 725/100; 725/89

(57) ABSTRACT

A method of processing files for data broadcasting is disclosed for shortening an initial preparation period for start of execution of the data broadcasting the execution speed of the data broadcasting, wherein the method comprises the steps of: a demultiplexer separating, files for data broadcasting from received television broadcast signals, and storing the separated files for data broadcasting in a memory; a controller retrieving, encoded files among the stored files for data broadcasting; a decoder decoding, the retrieved encoded files, and storing the decoded files in the memory; and executing the data broadcasting using the files for data broadcasting stored in the memory if instructions to execute the data broadcasting are input after the encoded files are decoded and then stored

### CROSS REFERENCE TO RELATED APPLICATIONS

Pursuant to 35 U.S.C. § 119(a), this application claims the benefit of earlier filing date and right of priority to Korean Patent Application No. 10-2004-0055878, filed on Jul. 19, 2004, the content of which is hereby incorporated by reference herein in its entirety.

### BACKGROUND OF THE INVENTION

1. Field of the Invention

The present invention relates to a method of processing files for data broadcasting, wherein an initial preparation period during which the execution of data broadcasting is prepared in response to instructions to execute a data broadcasting program is shortened and the execution speed of the data broadcasting is improved by prearranged decoding and then storing encoded files among files for data broadcasting separated from television broadcast signals.

2. Description of the Related Art

Data broadcasting broadcasts files for data broadcasting together with television broadcast signals in a case where the television broadcast signals are broadcast through certain transmission media such as sky waves, satellites, ground waves, cables or wires. The files for data broadcasting include a variety of broadcast content-related containing object information on various kinds of objects such as characters, properties and plots displayed in pictures corresponding to the television broadcast signals, and additional service information such as content addresses of these objects, electronic commercial transactions and electronic shopping. The files for data broadcasting contained in the television broadcast signals allow users to acquire a variety of information related to various kinds of objects, such as characters and properties displayed in pictures corresponding to the television broadcast signals, and additional service information, and to use services such as electronic commercial transactions and electronic shopping through Internet communication, while the users simultaneously watch programs of the television broadcast signals received by broadcast signal receivers such as digital television sets and set top boxes.

In a bid to watch the data broadcasting, a broadcast signal receiver should receive television broadcast signals, separate files for data broadcasting from the received television broadcast signals, and then store the files in a memory. The files for data broadcasting are generally broadcast with encoded files are included therein to enhance a transmission rate.

Therefore, when a broadcast signal receiver executes data broadcasting in response to execution instructions of the data broadcasting, encoded files in the stored files for data broadcasting are first decoded, and the data broadcasting is then executed. Such a conventional technique will be described in detail with reference to FIGS. 1a and 1b.

FIGS. 1a and 1b are flow charts illustrating a conventional method of processing files for data broadcasting. As illustrated in the figures, when a broadcasting station broadcasts television broadcast signals containing predetermined files for data broadcasting, a broadcast signal receiver receives television broadcast signals (S100), the files for data broadcasting are separated from the received the television broadcast signals (S102), and the separated files for data broadcasting are stored in a memory (S104).

In next step S106, it is determined whether all the files for data broadcasting are stored in the memory. If it is determined that all the files for data broadcasting have not yet been stored in the memory, the flow returns to step S102 and the operation for separating files for data broadcasting from the television broadcast signals and storing the separated files for data broadcasting in the memory is repeatedly performed.

If it is determined in step S106 that all the files for data broadcasting have been stored in the memory, the broadcast signal receiver indicates that preparation to execute the data broadcasting has been completed (S108).

If a user instructs to execute the data broadcasting in next step S110, it is determined whether encoded files are included in the files for data broadcasting stored in the memory (S112).

If it is determined in step S112 that encoded files are included in the files for data broadcasting, the encoded files are decoded (SI 14). Then, it is determined whether a condition under which data broadcasting can be executed is satisfied (SI 16). For example, if all the encoded files among the files for data broadcasting stored in the memory have been decoded, it is determined that the execution condition is satisfied.

If it is determined in step S112 that there is no encoded file in the files for data broadcasting or it is determined in step S116 that a condition for executing the data broadcasting is satisfied, data broadcasting is executed, so that a user can obtain a variety of information on various kinds of objects such as characters and properties and additional service information and utilize services such as electronic commercial transactions and electronic shopping through Internet communication (S118).

In next step S120, it is determined whether data broadcasting is to be terminated. Here, if a user of a broadcast signal receiver instructs to terminate the data broadcasting, it may be determined as the termination of the data broadcasting. Further, if data broadcasting cannot be executed due to the termination of a currently broadcast program of broadcast signals, it may also be determined as the termination of the data broadcasting.

If it is determined in step S120 that data broadcasting is not to be terminated, the flow returns to step S118 and the data broadcasting is continuously executed. On the contrary, if it is determined in step S120 that data broadcasting is to be terminated, the broadcast signal receiver terminates the execution of the data broadcasting.

According to such a conventional processing method, if there are encoded files among the files for data broadcasting that have been separated from television broadcast signals, the encoded files are stored in a memory. When data broadcasting is intended to be executed, the encoded files are decoded and the data broadcasting then begins to be executed. It takes a relatively great deal of time to decode the encoded files.

Therefore, when a user instructs to execute data broadcasting, the data broadcasting cannot be immediately executed and is delayed as much time as it takes to decode the encoded files. As a result, there arises a case where a user cannot obtain information on a desired object.

For example, there are many cases where, when a user instructs to execute data broadcasting so as to identify information on desired objects including characters and properties displayed on a screen while watching programs of television broadcast signals received by a broadcast signal receiver over a certain channel, the execution of the data broadcasting is delayed as much time as it takes to decode encoded files, and a period of time during which the corresponding objects are displayed on the screen passes due to the delayed time. In this case, there is a problem in that the user cannot obtain information on the corresponding objects.

Further, when a user requests information on a desired object by locating a cursor at a position where the object is displayed while data broadcasting is executed, the information the corresponding object stored in a memory is read and then displayed on a screen. However, if the information on the corresponding object is stored as an encoded file, there is a problem in that, since the corresponding encoded file is decoded to display the object, the execution speed of data broadcasting is slowed as much time as it takes to decode the encoded file.

### SUMMARY OF THE INVENTION

Accordingly, it is an object of the present invention to provide a method of processing files for data broadcasting, wherein the data broadcasting can be executed immediately when there are instructions to execute the data broadcasting.

It is another object of the present invention to provide a method of processing files for data broadcasting, wherein an initial preparation period during which the execution of data broadcasting is prepared in response to execution instructions of the data broadcasting is shortened and the execution speed of the data broadcasting in response to the user's instructions is enhanced by prearranged decoding and then storing all encoded files among files for data broadcasting that have been stored in a memory.

A method of processing files for data broadcasting according to the present invention for achieving the objects comprises the steps of: separating, by a demultiplexer, files for data broadcasting from received television broadcast signals, and storing the separated files for data broadcasting in a memory; searching, by a controller, encoded files among the stored files for data broadcasting; decoding, by a decoder, the searched encoded files, and storing the decoded files in the memory; and executing the data broadcasting using the files for data broadcasting stored in the memory if instructions to execute the data broadcasting are inputted after the encoded files are decoded and then stored.

The step of retrieving the encoded files further comprises the step of sequentially reading each of the files for data broadcasting stored in the memory and then determining whether the files are encoded.

The method may further comprises the steps of: determining whether preparation for executing the data broadcasting has been completed; and if the preparation for executing the data broadcasting has been completed, indicating the completion of the execution preparation thereof. The step of determining whether the preparation for executing the data broadcasting has been completed is performed by determining that the execution preparation has been completed if all the encoded files among the stored files for data broadcasting have been decoded. Alternatively, the step of determining whether the preparation for executing the data broadcasting has been completed is performed by determining that the execution preparation has been completed if all encoded files for data broadcasting to be first displayed on a screen have been decoded upon execution of the data broadcasting.

The method further comprises the steps of: determining whether the data broadcasting is to be terminated; and if it is determined that the data broadcasting is to be terminated, terminating the data broadcasting. The step of determining whether the data broadcasting is to be terminated is performed by determining that the data broadcasting is to be terminated if instructions to terminate the data broadcasting are inputted via a user interface or a currently received program of broadcast signals is terminated.

### BRIEF DESCRIPTION OF THE DRAWINGS

The above and other objects, features and advantages of the present invention will become apparent from the following description of a preferred embodiment given in conjunction with the accompanying drawings, in which:

FIGS. 1a and 1b are flow charts illustrating a conventional method of processing files for data broadcasting;

FIG. 2 is a block diagram illustrating a configuration of a broadcast signal receiver to which a processing method of the present invention is applied;

FIGS. 3a and 3b are flow charts illustrating the processing method of the present invention; and

FIGS. 4a and 4b are views illustrating an operation of decoding files for data broadcasting in accordance with the processing method of the present invention.

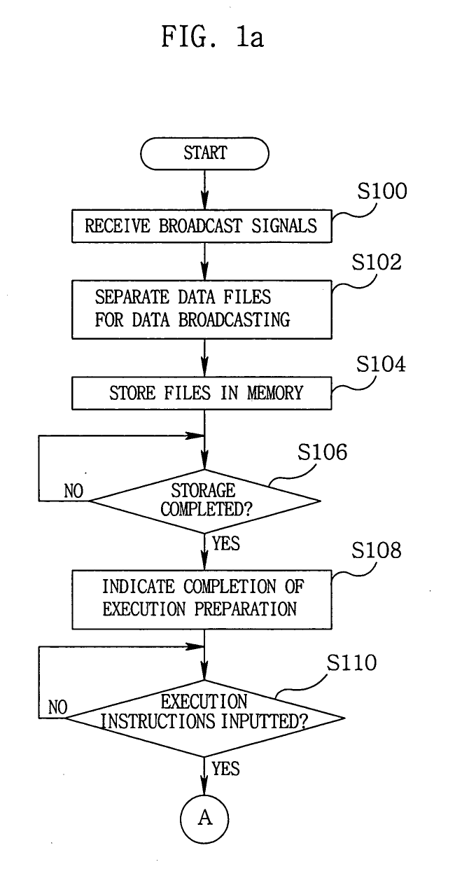

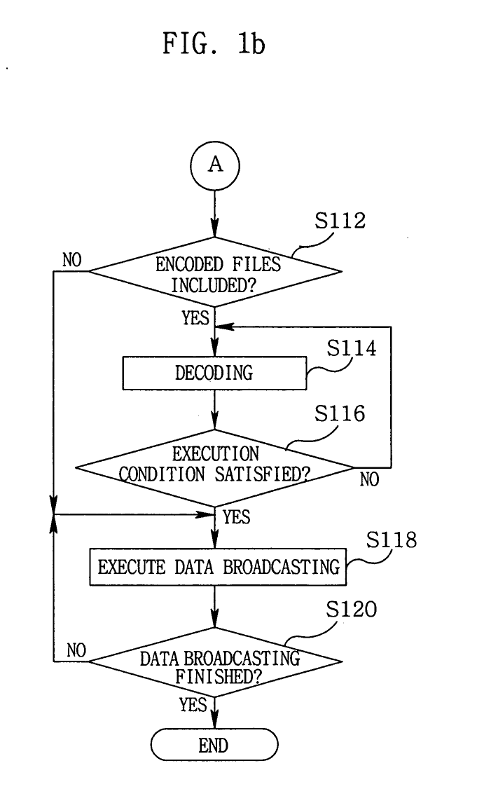

### DETAILED DESCRIPTION OF THE INVENTION

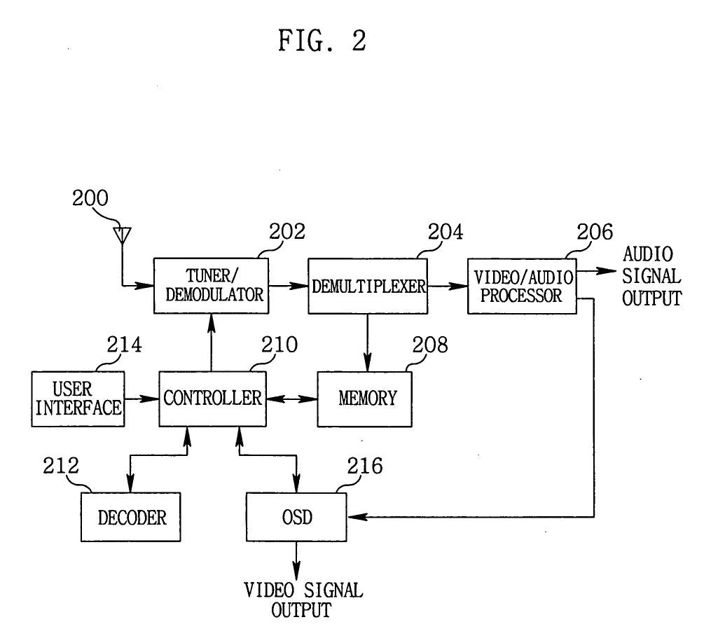

Hereinafter, a method of processing files for data broadcasting according to the present invention will be described in detail with reference to FIGS. 2 to 4a and 4b.

FIG. 2 is a block diagram illustrating a configuration of a broadcast signal receiver to which a processing method of the present invention is applied. Reference numeral 200 is an antenna, and reference numeral 202 is a tuner/demodulator for outputting a broadcast signal stream by tuning and demodulating television broadcast signals over a certain channel received via the antenna (200). Reference numeral 204 is a demultiplexer for separating video signals, audio signals and files for data broadcasting from the stream outputted from the tuner/demodulator (202).

Reference numeral 206 is a video/audio processor for processing video and audio signals separated by the demultiplexer (204). Reference numeral 208 is a memory for storing the files for data broadcasting, which have been separated by the demultiplexer (204).

Reference numeral 210 is a controller for performing a control by which the tuner/demodulator (202) tunes and demodulates television broadcast signals of a certain channel in response to user's instructions. Further, if there are encoded files among the files for data broadcasting stored in the memory (208), the controller (210) performs a control by which the encoded files are decoded and then stored in the memory (208). If instructions to execute data broadcasting are issued, the controller (210) controls the execution of the data broadcasting.

Reference numeral 212 is a decoder for decoding the encoded files under the control of the controller (210). Reference numeral 214 is a user interface for inputting operation instructions issued by a user's manipulation into the controller (210).

Reference numeral 216 is an OSD (On Screen Display). If data broadcasting is executed, the OSD (216) generates signals corresponding to the content of data broadcasting to be displayed on a screen and combines the generated signals with video signals processed by the video/audio processor (206).

In the broadcast signal receiver thus configured, if a user manipulates the user interface (214) to receive television broadcast signals of a certain channel, the controller (210) controls the tuner/demodulator (262) to output a broadcast signal stream by tuning the television broadcast signals of the channel in response to the user's instructions and demodulating the tuned television broadcast signals.

The demultiplexer (204) separates the broadcast signal stream outputted by the tuner/demodulator (202) into video and audio signals, and files for data broadcasting. The separated video and audio signals are processed and then outputted by the video/audio processor (206) so that the user watches and hears the video and audio signals. Further, the files for data broadcasting separated by the demultiplexer (204) are stored in the memory (208).

In this state, the controller (210) detects whether there are encoded files among the files for data broadcasting stored in the memory (208) in response to the control method of the present invention. Further, if encoded files have been stored in the memory (208), the controller (210) retrieves the encoded files, causes the decoder (212) to decode the retrieved files, and stores the decoded files in the memory (208).

In the state where all the encoded files among the files for data broadcasting stored in the memory (208) have been decoded and then stored again in the memory (208) as described above, if a user instructs to execute data broadcasting by manipulating the user interface (214), the controller (210) reads the files for data broadcasting (i.e., the decoded files) stored in the memory (208).

If the files for data broadcasting are read, the controller (210) executes the data broadcasting. In other words, the controller (210) generates signals corresponding to the content of data broadcasting to be displayed on the screen by controlling the OSD (216) depending on the read files for data broadcasting, and the generated signals are mixed with video signals processed by the video/audio processor (206) and then outputted so as to be displayed on the screen.

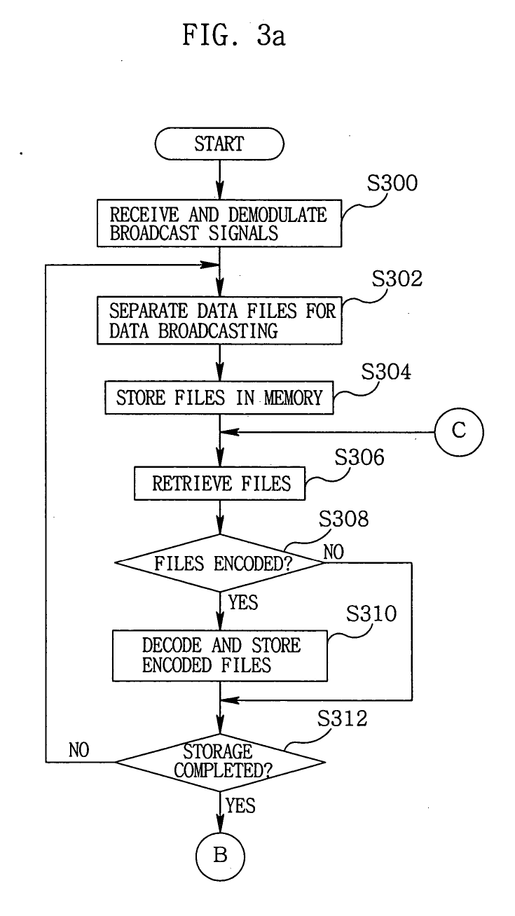

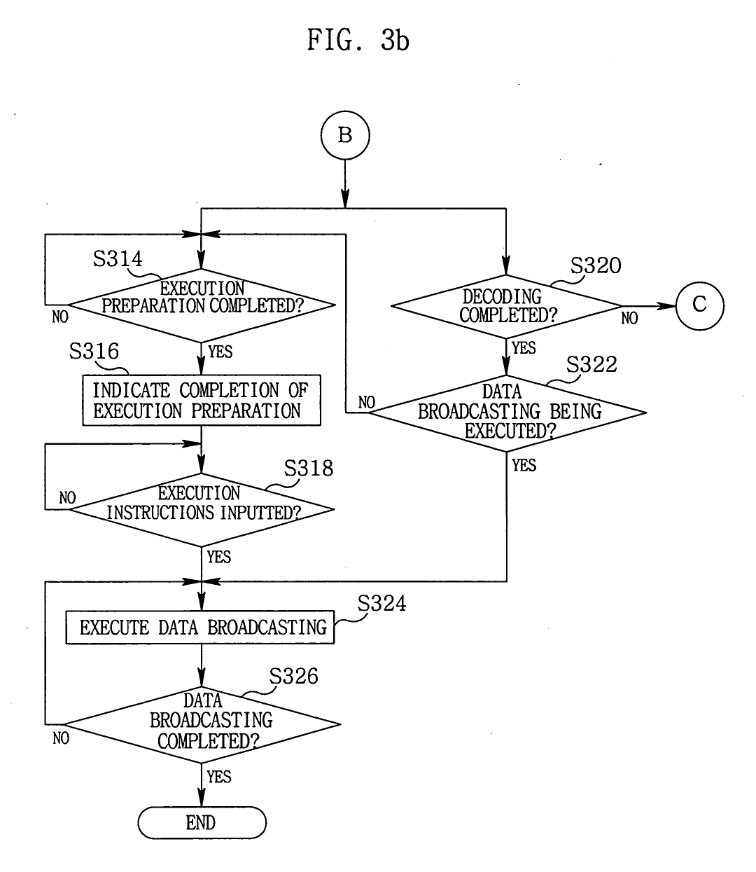

Meanwhile, FIGS. 3a and 3b are flow charts illustrating the processing method of the present invention. As shown in the figures, the tuner/demodulator (202) receives and demodulates television broadcast signals of a certain channel and outputs a broadcast signal stream under the control of the controller (210) (step 300). The demultiplexer (204) separates files for data broadcasting from the broadcast signal stream outputted by the tuner/demodulator (202) (step 302), and the separated files for data broadcasting are stored in the memory (208) (step 304).

In subsequent step 306, the controller (210) sequentially reads the files for data broadcasting stored in the memory (208) one by one, and determines whether the retrieved files are encoded files (step 308). If it is determined in step 308 that the retrieved files are encoded files, the controller (210) inputs the encoded files into the decoder (212) where the encoded files are decoded, and stores the decoded files in the memory (208) (step 310).

In next step 312, the controller (210) determines whether the storage of the files for data broadcasting has been completed. If it is determined in step 312 that the storage of the files for data broadcasting has not been completed, the flow returns to step 302 and the controller (210) stores files for data broadcasting separated from the received television broadcast signals in the memory (208) and reads the stored files for data broadcasting. If the read files are read files, the controller (210) repeatedly performs the operations of causing the decoder (212) to decode the encoded files and storing the decoded files in the memory (208).

Further, if it is determined in step 312 that the storage of the files for data broadcasting has been completed, the controller (210) determines whether preparation to execute the data broadcasting has been completed (step 314). A for the completion of the execution preparation of the data broadcasting, for example, if some of the encoded files have not yet been decoded and encoded files to be first displayed on the screen upon execution of the data broadcasting have been completely decoded, the controller (210) may determine that a condition under which the data broadcasting can be executed is satisfied. Further, if all the encoded files among the files for data broadcasting stored in the memory (208) have been decoded, the controller (210) may determine that the execution condition is satisfied.

If it is determined in step 314 that the preparation to execute the data broadcasting has been completed, the controller (210) indicates that the execution preparation of the data broadcasting has been completed (step 316). A for the indication of the completion of the execution preparation of the data broadcasting, for example, the controller (210) may control the OSD (216) to display the completion of the execution preparation on the screen.

In next step 318, the controller (210) determines whether a user manipulates the user interface (214) to seeing an instruction for executing of the data broadcasting has been inputted (214).

Further, while performing steps 314 to 318, the controller (210) simultaneously determines whether all encoded files among the files for data broadcasting stored in the memory (208) have been decoded and then stored in the memory (208) (step 320). If it is determined in step 320 that some of the encoded files have not yet been decoded, flow returns to step 306 and the controller (210) reads the files for data broadcasting stored in the memory (208). Further, if the read files are encoded files, the controller repeatedly performs the operations of causing the decoder (212) to decode the encoded files and storing the decoded files in the memory.

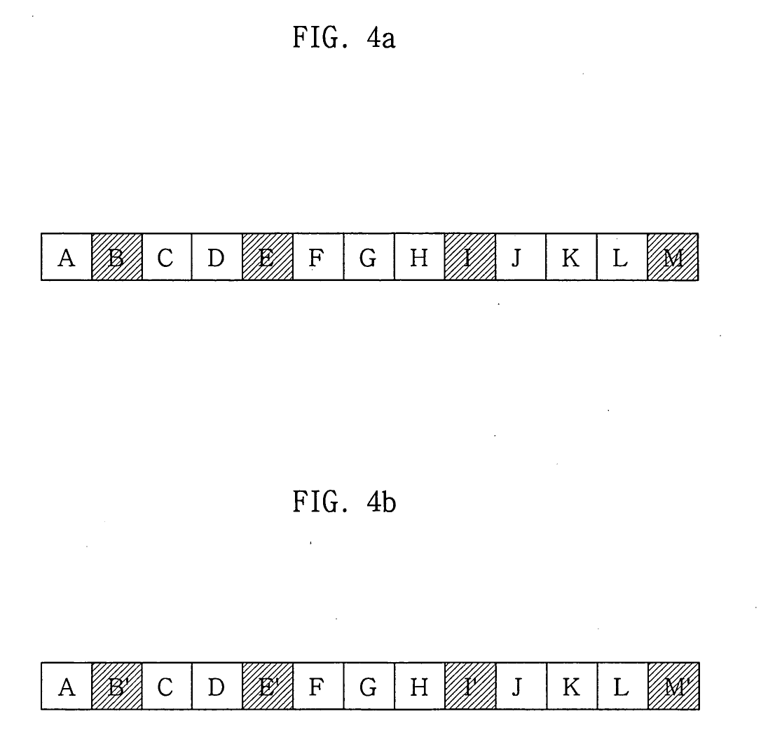

For example, as shown in FIG. 4a, the demultiplexer (204) separates files for data broadcasting (A to M), which in turn are stored in the memory (208). If files (B, E, I, M) of the stored files (A to M) are encoded files, the controller (210) sequentially reads each of the files for data broadcasting (A to M) stored in the memory (208) and retrieves the encoded files (B, E, I, M). The encoded files retrieved by the controller (210) are decoded by the decoder (212), and the decoded files (B′, E′, I′, M′) are stored in the memory (208).

If it is determined in step 320 that all the encoded files have been decoded and then stored in the memory (208), the controller (210) determines whether the data broadcasting is currently being executed (step 322). If it is determined in step 322 that the data broadcasting is not being executed, determination is made as to whether the preparation to execute the data broadcasting has been completed (step 314). If it is determined in step 314 that the preparation to execute the data broadcasting has been completed, the completion of the execution preparation of the data broadcasting is indicated (step 316). Then, determination is made as to whether instructions to execute the data broadcasting are input (step 318).

If it is determined in step 318 that the instructions to execute the data broadcasting are input or if it is determined in step 322 that the data broadcasting is currently being executed, the controller (210) executes the data broadcasting using the files for data broadcasting stored in the memory.

In the state where the data broadcasting is executed as described earlier, the controller (210) determines whether the data broadcasting is to be terminated (step 326). If the user of the broadcast signal receiver instructs to terminate the data broadcasting, this may be discriminated as the termination of the data broadcasting. Further, if a currently received program of broadcast signals is terminated to disable the data broadcasting from being executed, this may be interpreted as the termination of the data broadcasting.

As a result of discrimination at step 326, if it is determined that the data broadcasting is not terminated, flow returns to step 324 and the data broadcasting is continuously executed in response to the user's instructions inputted through the user interface (214). Further, if it is determined in step 322 that the data broadcasting is to be terminated, the broadcast signal receiver terminates the execution of the data broadcasting.

According to the present invention, the controller (210) beforehand decodes the encoded files among the files for data broadcasting stored in the memory (208) and stores the decoded files in the memory (208), thereby reducing the time required for the data broadcasting being immediately executed and then initially displayed on the screen. Further, according to the present invention, even when a user places a the cursor on the position of a desired object displayed on the screen so as to display information on the desired object while the data broadcasting is executed, the information on the desired object is immediately read from the memory (208) and then displayed on the screen, thereby reducing time required for executing the data broadcasting in response to the user's instructions.

As apparent from the foregoing, the present invention has an advantage in that an initial preparation period from the time when instructions to execute data broadcasting are issued to the time when the data broadcasting begins to be executed can be shortened by searching whether there are encoded files upon storage of files for data broadcasting in a memory, decoding the searched encoded files, and then storing the decoded files in the memory. Further, the present invention has an advantage in that time required for executing the data broadcasting in response to user's instructions can be reduced.

Although the present invention has been described in detail in connection with the preferred embodiment, it will be apparent that various modifications and changes can be made thereto without departing from the scope of the present invention. Therefore, the scope of the present invention should not be defined by the embodiment but should be defined by the appended claims and equivalents thereof.

What is claimed is:

1. A method of processing files for data broadcasting, comprising the steps of:
a demultiplexer separating, files for data broadcasting from received television broadcast signals, and storing the separated files for data broadcasting in a memory;
a controller retrieving, encoded files among the files for data broadcasting stored in the memory;
a decoder decoding, the retrieved encoded files, and storing the decoded files in the memory; and
executing the data broadcasting using the files for data broadcasting stored in the memory if instructions to execute the data broadcasting are inputted after the encoded files are decoded and then stored.

2. The method as claimed in claim 1, wherein the step of retrieving the encoded files comprises the step of sequentially reading each of the files for data broadcasting stored in the memory and then determining whether the files are encoded files.

3. The method as claimed in claim 1, further comprising the steps of:
determining whether preparation to execute the data broadcasting has been completed; before the instructions to execute the data broadcasting are inputted;
and indicating the completion of the execution preparation thereof, if the preparation to execute the data broadcasting has been completed.

4. The method as claimed in claim 3, wherein the step of determining whether the preparation to execute the data broadcasting has been completed is discriminated completion of execution preparation of data broadcasting if all the encoded files among the stored files for data broadcasting have been decoded.

5. The method as claimed in claim 3, wherein the step of determining whether the preparation to execute the data broadcasting has been completed is discriminated completion of by determining that the execution preparation of data broadcasting if all encoded files for data broadcasting to be first displayed on a screen have been decoded upon execution of the data broadcasting.

6. The method as claimed in claim 1, further comprising the steps of:
determining termination of the data broadcasting; and
terminating the data broadcasting, if it is determined that the data broadcasting has been terminated

7. The method as claimed in claim 6, wherein the step of determining the termination termination instruction of the data ion of program of a currently received
